(19) United States
(12) Patent Application Publication
(10) Pub. No.: US 2007/0170405 A1
(43) Pub. Date: Jul. 26, 2007

(54) Tool devices

(76) Inventor: Robert Gallart, Brooklyn, NY (US)

Correspondence Address: LAW OFFICE OF MORRIS E. COHEN, 1122 CONEY ISLAND AVENUE, SUITE 217, BROOKLYN, NY, 11230, US

(21) Appl. No.: 11/364,830

(22) Filed: Feb. 27, 2006

Related U.S. Application Data
(60) Provisional application No. 60/656,585, filed on Feb. 25, 2005.

(51) Int. Cl. B66F 7/26

(52) U.S. Cl. 254/45

(57) ABSTRACT

Tools are provided having a variety of uses, such as to support or raise an object, or exert force against a structure. In preferred methods, the tools are particularly suitable for use by rescue or emergency personnel to raise a vehicle, to open a door, or so forth.

### RELATED APPLICATIONS

The present application claims the priority of U.S. Provisional Application Ser. No. 60/656,585 filed Feb. 25, 2005, which is hereby fully incorporated herein by reference.

### BACKGROUND OF THE INVENTION

Emergency and law enforcement personnel are trained to provide assistance in a variety of contexts; to do so, it is desirable to provide such assistance in as rapid and effective a fashion as possible. Accordingly, it would beneficial in the art to provide improved tools which increase the effectiveness, safety and/or speed of rescue and other assistance. It would also be beneficial to provide tools for use in a variety of applications which have a range of utilities to improve upon prior tools in the art.

### SUMMARY OF THE INVENTION

In accordance with the present inventions, tools are provided having a variety of uses. The tools preferably include a two part assembly. This assembly includes an upper component in the form of an extension device forming the assembly's first end. The extension device is a variable length component, whose length can be adjusted by the user.

The tool further includes a lower component in the form of a stand or a force bar forming the second end of the assembly. When the upper and lower component are assembled together into a single unit, the tool device is suitable for use in a variety of contexts, whether to support, or raise an object or structure, or to exert force against an object or structure, or so forth.

Alternatively a single integral unit can be provided, wherein no assembly is required. However, two connecting units are preferred; in this preferred embodiment both the assembly of the device and the adjustment of the upper component can be used to vary the device's overall length.

In preferred embodiments, the tool devices can be used in rescue, law enforcement, or emergency situations, although it will be understood that the uses of the device are not intended to be limited to those preferred embodiments. For example, in one embodiment of the method of the invention, the tool devices can be used to support and stabilize a vehicle that has just been in an automobile accident. Or, in a second embodiment of the method, the stand device can be used to raise the vehicle to extricate someone trapped underneath. Or, in yet a further embodiment, the force bar device can be used to open up a door, by positioning it against a doorframe.

Further aspects, advantages and objects of the present inventions will become apparent in conjunction with the detailed disclosure provided herein.

### BRIEF DESCRIPTION OF DRAWINGS

FIG. 1 is a front view of an upper component of an tool device in accordance with the present invention for use with the stand embodiments disclosed herein, with FIG. 1(a) being a front view with the head placed on the rod, and FIG. 1(b) being a front view with the head removed for illustration purposes.

FIGS. 2 through 5 are illustrations of a lower component of the tool device in the stand embodiment of the invention, with FIG. 2 being a front view, FIG. 3 being a side view, FIG. 4 being a top view and FIG. 5 being a bottom view thereof.

FIG. 6 is a front view of the stand embodiment of the invention wherein the upper and lower components have been assembled together to form a single unit.

FIG. 7 is a front view of the upper component of the tool device for use with the force bar embodiments disclosed herein.

FIG. 8 is an illustration of the lower component of the force bar tool device of the present invention, with FIG. 8a being a side view, and FIG. 8b being a front view thereof.

FIG. 9 is a perspective view of the force bar embodiment of the invention, wherein the upper and lower components have been assembled together into a single unit.

FIG. 10 is a schematic view of a metal pin for attachment of the upper and lower components of the tool device in accordance with the present invention.

### DETAILED DESCRIPTION OF THE DRAWINGS AND THE PREFERRED EMBODIMENTS

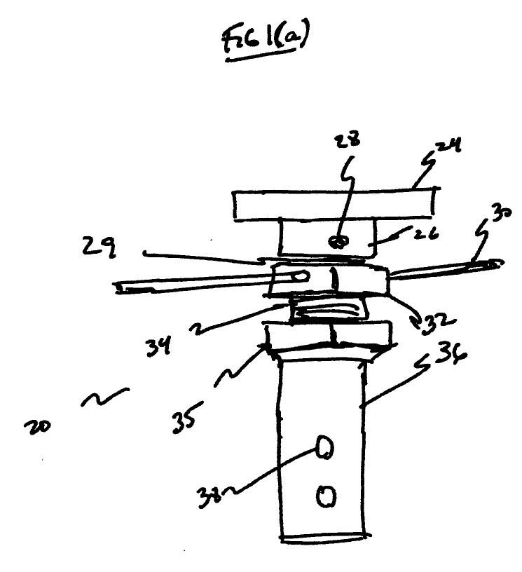

In accordance with the present invention, an extension device 20 is provided as shown in FIG. 1. Extension device 20 is the upper component of an two part assembly, the lower component being a stand or bar. The fully assembled structure is used to support, level, balance, or raise an object such as a vehicle or structure; or to exert force against an object of interest, such as a door frame; or so forth, as further discussed below.

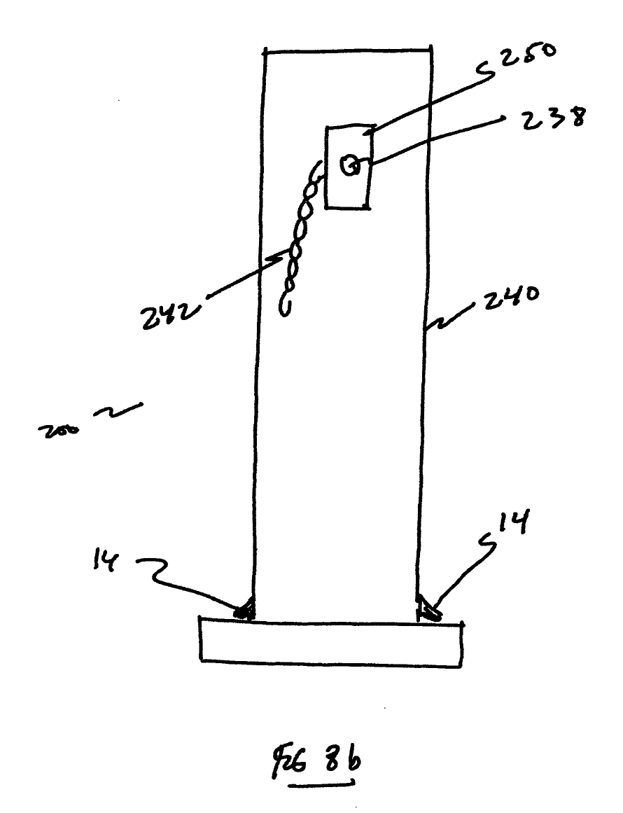

As shown in FIGS. 1 and 7, extension device 20 includes a tube or pipe 36 having pairs of holes 38, each pair of holes 38 being provided on the front and back surfaces of the tube (or the left and right surfaces, depending on one's perspective). This tube 36 is provided for attachment of the extension device to a corresponding mating component.

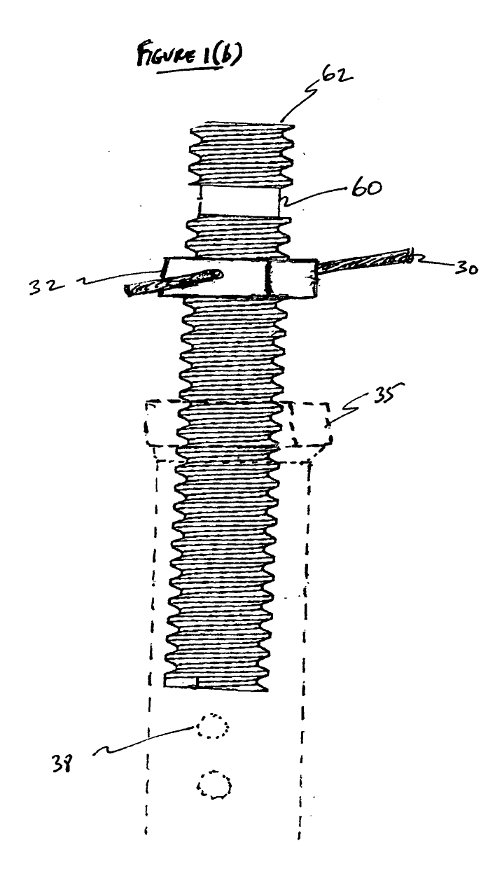

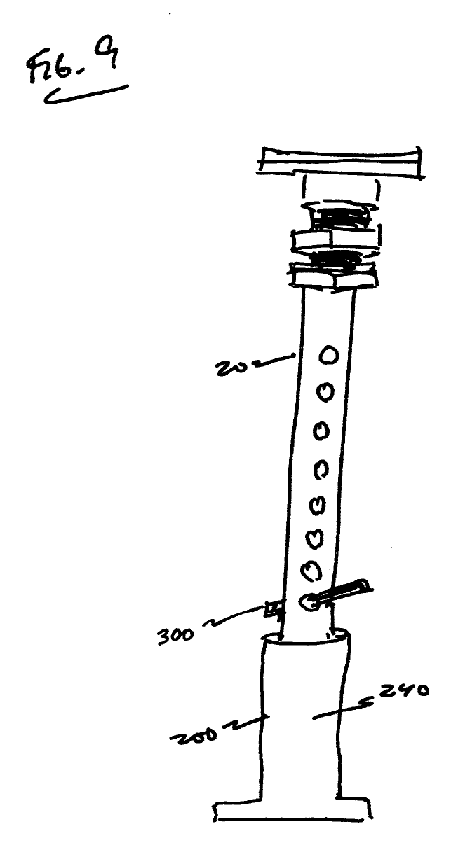

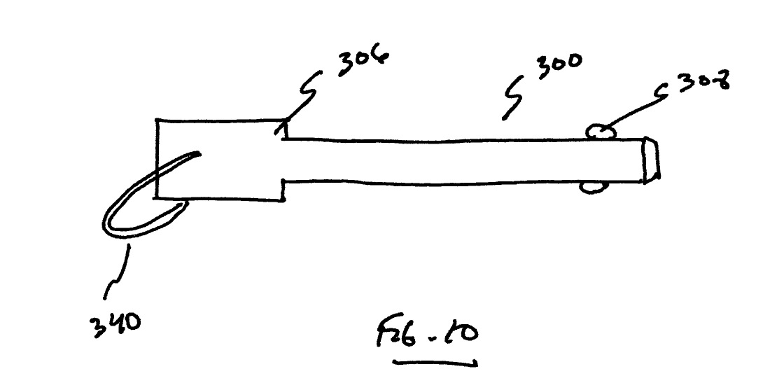

In preferred embodiments, extension device 20 is provided for use with a stand 100 as shown in FIGS. 2-6, or with a force bar 200, as shown for example in FIGS. 8-9. A shorter tube 36 is preferred for the stand embodiment as shown in FIG. 1, while a longer tube 36 is used with the force bar embodiment, as shown in FIG. 7, with the lengths being configured for the intended usages. For example, in one preferred embodiment, the stand can vary in length from four to six inches, while in a preferred embodiment the force bar can vary in length from twenty eight to forty four inches, However, in general, the metal tubes 140 (see e.g. FIGS. 2, 3 and 4) or 240 (see e.g. FIGS. 8a and 8b) can be of any length desired.

In a further preferred embodiment, kits can be provided having multiple stands, each stand having a tube of a different length to provide flexibility for use in various contexts that may arise. For example, in one embodiment, a kit can be provided having two or more stands, such as a first stand varying in length from four to six inches, a second stand varying in length from six to ten inches, a third stand varying in length from ten to fourteen inches, a fourth stand varying in length from fourteen to nineteen inches, and so forth. Likewise, kits can be provided with force bars of multiple lengths as well.

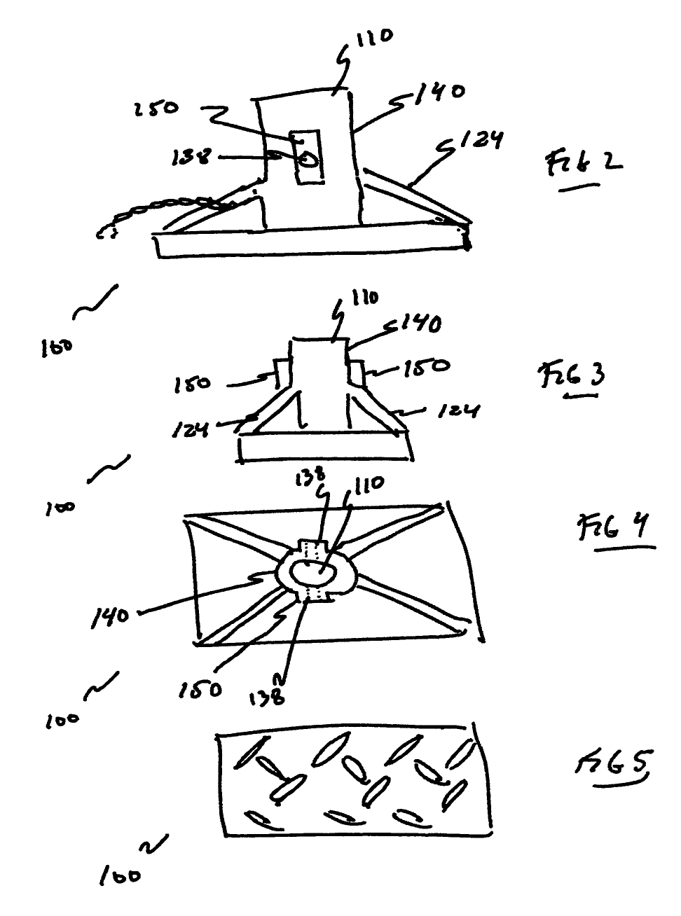

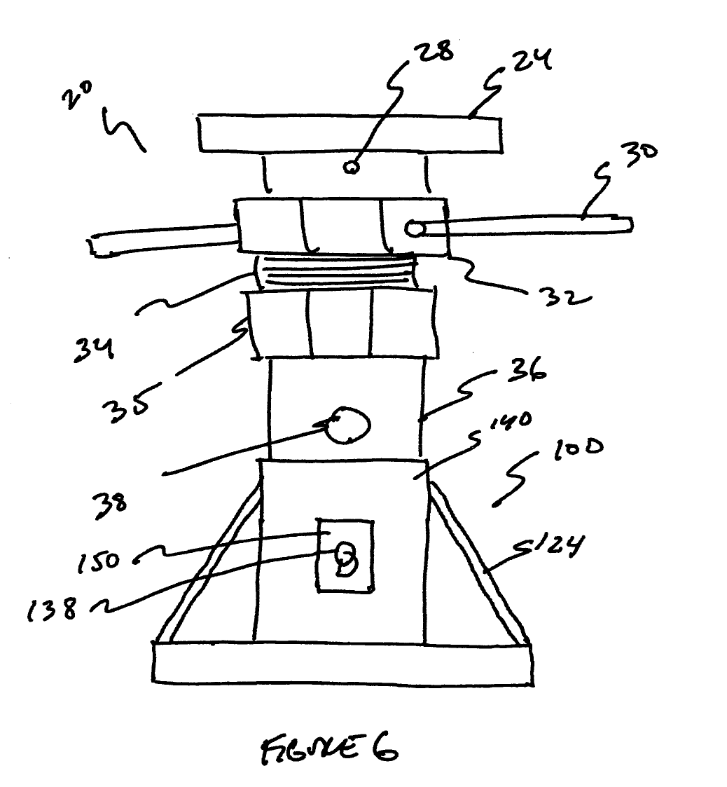

As shown in FIGS. 2 and 3, stand 100 includes a tube 140. Force bar 200 likewise includes a tube 240, as shown in FIGS. 8a and 8b. Stand 100 also includes a pair of holes 138, as shown in FIGS. 2 and 4; with the force bar including a pair of holes 238 (one of which is shown in FIGS. 8b).

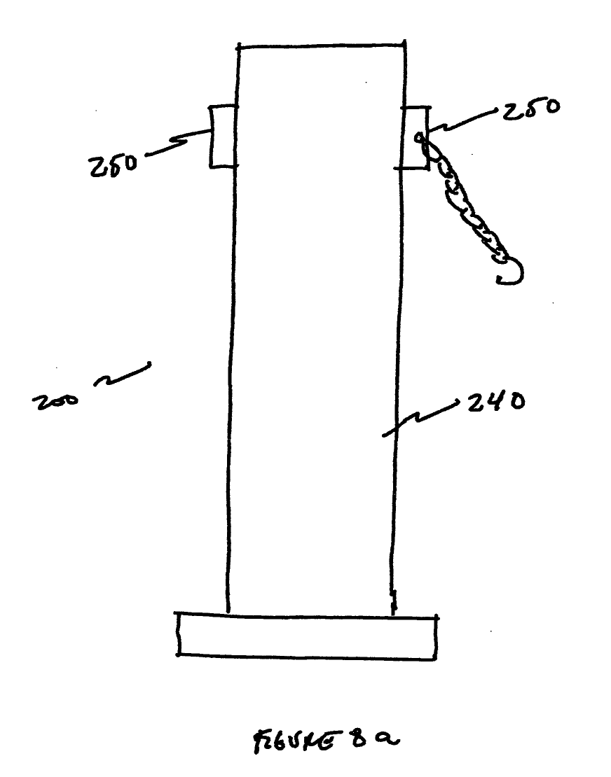

Tubes 140 and 240 each have a diameter which is slightly greater than that of tube 36. As a result, tube 36 of extension device 20 can be inserted into corresponding tube 140 of the stand 100 as shown in FIG. 6, or into tube 240 of the force bar 200 as shown in FIG. 9.

Extension device 20 includes several pairs of holes 38, with each pair of holes 38 being provided at a desired height above the pair below it. Any of these pairs of holes can be used to connect the extension tube 20 to the stand 100 or force bar 200, so as to select the desired resting length of the tool, the resting length being the initial length of the tool device (and the length of the tool being the distance from the top of the head to the bottom of the base when the upper component and lower component are attached together). As discussed below, the length of the tool can be further adjusted from its resting length by rotation of the handle and rod of the tool. Thus, the length of the tool can be increased above (or decreased below) its resting length as is desirable in numerous applications.

During insertion of tube 36 into tube 140 or 240, tube 36 is rotated until one of the pairs of holes 38 of the extension device overlap with holes 138 or 238 of the stand or force bar. Preferably, in both the stand and force bar embodiments of the invention, the inner tube of the upper component (extension device) is steel and the outer tube (of the stand or force bar) is aluminum; with the base of the stands and force bar being aluminum and the heads of the extension device being steel. The use of both an inner tube and outer tube of steel is not preferred, due to the fact that steel does not comfortably slide within steel. However, it will be understood that the invention is not limited to the materials disclosed, as any other sufficiently durable materials can be used consistent with the invention.

Once the holes in the extension device 20 have been aligned with the holes in the stand or bar, a metal pin (such as shown in FIG. 10) is inserted through the aligned sets of holes. This metal pin passes through the outer hole (138 or 238) in the stand or bar, through a hole 38 in the tube of the extension device, through a further hole (38) in the extension device (on the opposite side of tube 36), through a further hole (138 or 238) in the stand or bar. In this manner, the tubes of the extension head 20 and the stand 100 (or the force bar 200) are assembled and connected to form a single unit.

Extension device 20 further includes a head 24 as shown in FIGS. 1 and 7. In the case of emergency operations on a vehicle, the head is the portion of the device which is propped or wedged against the underside of the vehicle during the rescue operation. In the case of fire rescue (e.g. when the force bar is used to open a door), the head is a portion of the device which is propped against one of the doorposts of a doorframe.

In the preferred embodiments, head 24 is a flat surface, as shown in FIGS. 1 and 7. Alternatively, the head can present an arcuate or curved top surface, such as a surface which is concave of any desired degree of curvature. In yet further alternate embodiments, the head can be provided with guide rails which flank the platform, each side rail forming a ledge, to provide enhanced stability to the positioning of the head.

The underside of head 24 of extension device 20 includes a neck 26 (i.e. a short post) which is affixed to the top of a rod 29 having screw threads 34. Rod 29 can be a separate piece which connects neck 26 and nut 32, or can be an integral part of nut 32 which extends therefrom. In either construction, rod 29 is securely affixed to nut 32.

Head 24 can be attached at neck 26 to rod 29 using two screws or pins 28, or using any other desired means. Preferably, rod 29 is provided with a region or groove 60 near its top which is free of screw threads 34, as shown for example in FIG. 1(b). For illustration purposes, in FIG. 1(b), rod 29 is shown with head 24 removed, and with the lower nut and tube shown in dotted outline. (In normal assembly, the head is placed onto the rod 29, with the inside of head 24 resting on the top 62 of the rod 29, and with neck 26 extending down along rod 29). When head 24 is on rod 29, the two screws 28 extend into region or groove 60 of the rod, with one screw or pin 28 extending from each side of neck 26. In this preferred embodiment, rotation of the rod 29 does not cause rotation of the head, or conversely the head can be rotated freely without affecting moving the rod 29, due to the fact that region 60 is free of screw threads, and the screws 28 merely extend into the groove without being attached to the rod 29. However, rotation of of nut 32, which is securely attached to the threaded rod 29 (e.g. by welding or so forth), causes rotation of the rod 29 into or out of nut 35.

Thus, in the preferred embodiment, neck or post 26 is loosely configured on the top of rod 29, such that the neck 26 does not snugly fit on top of the rod. Rather, a region or space 60 is provided between the rod and the inside surface of the post. Head 24 is secured to the post in that the screws extend into the region or space 60, even though the screws 28 and rod 29 are not attached. As the rod 29 has additional screw threads 34 provided above the screws 28, the head is prevented from being removed from the rod; if the head is pulled upward screws 28 hit the upper screw threads of the rod 29, preventing further upward movement and removal of the head.

The presence of thread free region 60 and the use of screws or pins 28 which extend into this region also facilitates the pivoting or tilting of the head. As a result of this region or space 60, head 24 can pivot or tilt slightly during use. Owing to the height of this thread-free region 60, the screws or pins 28 have some space to move upward and downward before hitting the screw threads 34 flanking region 60. In a preferred embodiment, neck 26 and nut 32 are spaced so that the bottom of neck 26 does not touch the top of the nut 32 when the head is flat; however, neck 26 can come into contact with the top of the nut 32 when the head pivots or tilts.

This pivoting of the head (which is a movement in the form of a limited rotation about the axis formed by screws or pins 28) has numerous advantages. For example, in one embodiment, the stand inventions can be used in emergency procedures on a vehicle in an accident. In such cases, if the vehicle is on an angle or the ground is on an angle (or both), the pivoting or flexing of the head makes it easier to place and secure stand 100 underneath the vehicle to stabilize it. Likewise, the pivoting can be used to prevent small shifts in the position of the car from causing the device to slip off of the part that it is propped against. Similarly, in the force bar embodiment, the pivoting prevents the device from sliding out and off of the door frame when pressure is applied.

Tube 36 further includes a lower nut 35 which is welded to tube 36. The threaded rod 29, as shown in FIGS. 1 and 7 rotates into lower nut 35. Preferably a very thick thread such as that used with heavy machinery is utilized. In one embodiment, for example, an acme thread can be used.

The extension device also includes an upper nut 32 having a handle 30. Handle 30 is preferably a bar which extends through a hole in the nut 32, such that the bar of the handle can easily slide in and out of the hole in the nut. The use of a straight rod which pulls through the hole as a handle, allows quick rotation of the nut using either side of the rod or both. The handle is also provided with ends of slightly increased diameter (compared to the diameter of the hole in the nut), preventing the handle from being removed from the nut.

Rotation of the nut 32 using handle 30 causes rod 29 to rotate into nut 35 and into tube 36. As a result, the overall length of the extension device 20 (and of the completed assembly having the stand or bar) can be varied by rotation of the handle 30. Rotation of handle 30 in a counterclockwise direction causes rod 29 to retracted from tube 36 thereby causing the device to be lengthened as the upper and lower components move away from each other; conversely, clockwise rotation, causes the length of the device to be shortened. As a result, the length of the device can be increased or decreased from its resting length by rotating handle 30 which causes rod 29 to retract from or go into tube 36. This in addition to the use of holes of differing heights on one of the components of the assembly, allows both selection of an initial resting length, and rotation of the device to dynamically increase or decrease the length of the device.

Preferably, rod 29 is slightly increased in diameter at its end (or is lacking screw threads) such that the rod 29 can not be rotated out of the nut 32. Also, in the preferred embodiments, the device is manually rotated to adjust its length. Alternatively, the device can be power driven, whether hydraulic force or so forth.

Depending on the desired application, the device can be configured such that rotation of the handle 30 in a plane (and concurrent rotation of the rod 29) allows increase and decrease of the length of the device with or without without concurrent rotation of the head 24 in that same plane. In other words, the rod and the head can be configured such that the head does or does not twist when the handle is rotated, as desired. In the preferred embodiment, as discussed above, the head rotates freely such that rotation of rod 29 does not cause rotation of head 24. Alternatively, the device can be configured such that rotation of rod 29 results in rotation of the head. For example, the screws 28 can extend from the neck into the rod itself, rather than into the region or space 60.

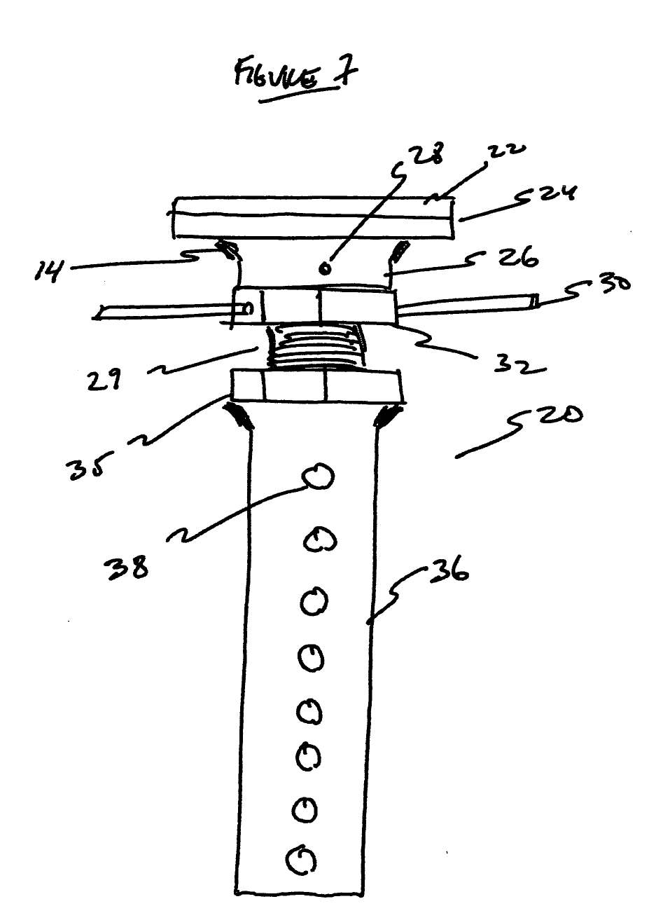

In various embodiments of the invention, one or more surfaces (e.g. the base) of the stand or force bar can be provided with a surface designed to minimize slippage. For example, in one preferred embodiment of the stands, a corrugated texture is provided on the surface of the base, it being intended for resting on the ground. In one preferred embodiment, this surface is provided with a diamond plate configuration. This diamond plate configuration is roughly illustrated in FIG. 5. Diamond plate surfacing is particularly effective as it grips many surfaces, including, but not limited to, paved, soil, and grass surfaces.

In an alternate or additional embodiment, a neoprene rubber coating or pad 22 many be utilized on head 24 to prevent the conduction of electricity, such as in hybrid or electric vehicles.

In a preferred embodiment of the bars, the surfaces of the head and base are provided with a rubber coating or pad as shown by layer 22 in FIG. 7. For example, a ¼ inch layer of neoprene rubber can be used. This embodiment is particularly helpful for use of the bars against a door frame to open a door. The rubber prevents slippage and allows more stable positioning. In addition, in the event that the force bar is for use in fire rescue, the use of neoprene rubber is preferred, as it does not burn as easily as some other forms of rubber and is not as affected by oil or gas. The rubber coating increases friction (preventing slippage) and/or can be used to prevent conduction of electricity in those situations where the device could come into contact with a source of electric current, such as in a hybrid or electric vehicle.

In the preferred embodiments of the invention, stand 100 further includes struts 124. Each strut can be attached at one end to the top surface of the base, and can be attached at the other end to the post. Struts 124 reinforce the device, allowing it to withstand higher compressive forces during use. Thus, when the device is supporting the weight of the automobile, the struts serve to provide the device with additional structural integrity.

In addition, to yet further increase the strength and durability of construction of the device, it is preferred that all of the individual components, such as the head and the post and so forth, be strongly welded together using military grade welding specifications. Such welding can be provided at each joint, with an example of welding at joint 14 being shown in FIG. 7.

In the preferred embodiment, the metal pin is inserted through blocks 150 in the stands and blocks 250 in the force bar embodiments. These blocks 150 and 250 are provided on either side of the post, and have the holes for the metal pin extending therethrough (as shown by the dotted lines in FIG. 4). The blocks are components which increase the tool material thickness (e.g. metal thickness) and therefore the strength of the device in the region where the pins are inserted. Or, looked at in another manner, the blocks effectively increase the pin thickness, further preventing the pin from being crushed under the application of heavy loads.

As shown in FIG. 10 and as discussed above, a metal pin 300 is used to secure the upper and lower components of the tool device together at a desired resting length. Preferably, the metal pin 300 is of a thickness and durability such that they can support several tons of weight. For example, in one preferred embodiment, the metal pins are of sufficient thickness such that they and the devices of the invention can withstand nine tons of weight on the head of the device, when the pin is assembled together.

Further preferably, the metal pin 300 includes a shoulder 306 on a first end and spring loaded ball bearings 308 on a second end. The shoulder 306 is configured of a diameter larger than that of holes 38, 138 and 238, preventing that end of the metal pin from being inserted too far into the holes. Ball bearing 308 likewise provide a diameter larger than that of the holes 38, 138 and 238. However, compression of the ball bearings 308 into the pin allow the pin to be easily inserted into and removed from the holes. As a result, the shoulder and ball bearing provide a safety mechanism keeping the pin securely in place and preventing it from coming out when the upper and lower components are assembled, or from coming out in the unlikely event that the pin bends under an excessive load.

As a further feature of the pin, it is preferred that the end next to the ball bearing be slightly tapered, as shown in FIG. 10, to ease the process of insertion of the pin into the tube. Furthermore, it is further preferred that a chain (such as chain 242 in FIG. 8b) be provided to the tool devices, allowing the ring 340 of metal pin 300 to be secured to the device to prevent accidental loss of the pin.

If desired, other methods can be used for affixation of the present heads to the stands and bars, consistent with the present invention. Any desired configuration for affixation can be used, with the present invention being intended to include any such additional configurations and methods for affixation.

Using the designs provided herein, the tools of the invention are provided with materials, dimensions and construction suitable to providing the force needed for the particular context of interest. Preferably, in accordance with the invention, the devices are all constructed from a suitably strong material (such as cold rolled steel), with the components thereof being cut out of a block or piece of metal and welded together. These parts are then themselves welded together to meet stringent specifications, preferably meeting military grade specifications or higher.

In general, the stands of the invention are designed to support at least a ton or more of weight on the head of the device when assembled, and preferably two or more tons, or five or more tons, or so forth depending on the context of intended use. In the preferred embodiments, the stands can support sufficient weight and provide sufficient force when wedged under a vehicle to lift that vehicle off of the ground. Likewise, the force bars of the invention are designed to exert several hundred pounds or more of force, and at least sufficient force to expand the distance between the opposing right doorpost and left doorpost of a doorframe, the expand the frame when the head and base are propped against the opposing doorposts.

Accordingly, numerous uses are contemplated of the present inventions, whether in emergency operations, law enforcement, or so forth. For example, the stands of the present invention are particularly useful in rescue operations to support a vehicle. Current methods, which utilize the inflation of air bags below the vehicle are rather slow and cumbersome; in contrast, the use of the present stands provides a steadier, safer, and more rapid and efficient method of stabilizing a vehicle that has been in an accident. For example, a spreader or ram device can be used to initially and rapidly raise the vehicle (e.g. in the event that a body is trapped underneath). One or more stands of the present invention can then be placed underneath the vehicle, with the handle of the stand being rotated to move the head upward until reaching the desired height to provide stabilization and firm support of the vehicle. In this embodiment, the pivoting of the head of the stand (as described above) is particularly helpful to address situations when the vehicle and/or the ground is at an angle, as well as to prevent shifts in vehicle position from dislodging the vehicle from the device.

Numerous uses are likewise contemplated of the force bars of the present invention. In one embodiment of the method for example, the bars can to allow rescue workers or law enforcement workers to open up a locked door. In this embodiment, one end of the force bar is affixed against the left doorpost of the doorframe, while the other end is affixed against the right doorpost. By rotating the handle, the length of the device is increased, pushing the left and right doorposts apart. With sufficient rotation, the doorframe is expanded to the point where the lock in the door moves sufficiently away from the cavity in the doorframe that the door can be easily opened, with little or no damage to the door.

In a further embodiment of the method, the force bar can be used across a window by firefighters to suspend a fan during a fire.

In yet a further embodiment of the invention, the force bar can be used vertically to support a doorpost in a fire or an earthquake or so forth.

In yet a further embodiment, the force bar can be used in trenching operations. For example, if a buried cable needs to be accessed, a hole is dug to reach the cable with plywood generally being used to shore up the sides of the hole and to prevent its collapse. In accordance with a method of the invention, the force bar can be extended against the plywood to keep it in place and prevent caving in.

In a further embodiment of the method, the force bar can be used in “dash dumping” operations. In such operations, when a dashboard of a vehicle is pushed into an engine compartment (e.g. using a ram), the force bar can be used on the passenger side for safety purposes to prevent the dashboard from returning back on that passenger's side.

In yet further embodiments, the force bar can even be used as an exercise device (e.g. whether to do chinups or so forth). Likewise, it will be understood that numerous other uses can be made of the inventions; although the above are recited for illustration purposes of several preferred embodiments, they are not meant to be limiting.

Having described this invention with regard to specific embodiments, it is to be understood that the description is not meant as a limitation since further embodiments, modifications and variations may be apparent or may suggest themselves to those skilled in the art. It is intended that the present application cover all such embodiments, modifications and variations.

What is claimed is:

1. An apparatus, comprising:
a tool comprising an upper component and a lower component;
said upper component comprising a head, and said lower component comprising a base;
wherein said upper component and said lower component can be connected together, said tool having a resting length when said upper component and said lower component are connected together;
wherein said upper component can be connected by the user to said second component in a first configuration or in a second configuration, said tool having a different resting length in said first configuration than in said second configuration;
and wherein, wherein said upper component is connected to said lower component in said first configuration or said second configuration, said head is placed against a desired first object, and said base is placed against a desired second object, a user can increase the length of said tool beyond said resting length so as to exert force against the first object and the second object.

2. An apparatus as claimed in claim 1, wherein said resting length can be increased by the user to increase the distance between said first object and said second object.

3. An apparatus as claimed in claim 1, wherein said tool can be used to lift a first object weighing at least a ton.

4. An apparatus as claimed in claim 1, wherein said tool can be used to lift a first object weighing at least five tons.

5. An apparatus as claimed in claim 1, wherein, when the first object is an automobile, and the second object is the ground, said resting length can be increased by the user to provide sufficient force to lift the automobile using said tool.

6. An apparatus as claimed in claim 1, wherein, when the first object and the second object are the right and left doorposts of a door frame, said resting length can be increased by the user to provide sufficient force to expand the distance between those right and left doorposts.

7. An apparatus as claimed in claim 1, wherein said upper component and said lower component can be connected together using a metal pin.

8. An apparatus as claimed in claim 1, wherein said head has a top surface and said top surface is flat.

9. An apparatus as claimed in claim 1, wherein said head has a top surface and said top surface is curved.

10. An apparatus as claimed in claim 1, wherein said head has a top surface and said top surface comprises guide rails.

11. An apparatus as claimed in claim 1, wherein said tool comprises a rod, and rotation of said rod changes said length of said tool.

12. An apparatus as claimed in claim 1, wherein said base comprises struts.

13. An apparatus as claimed in claim 1, wherein said base comprises a surface to minimize slippage.

14. An apparatus as claimed in claim 1, wherein said base comprises a diamond plate configuration.

15. An apparatus as claimed in claim 1, wherein said base comprises rubber.

16. An apparatus, comprising:
a tool comprising an upper component and a lower component;
said upper component comprising a head, and said lower component comprising a base, said tool further comprising a first tube of said upper component, and a second tube of said lower component;
wherein said first tube of said upper component and said second tube of said lower component can be connected together by a user in at least two configurations, a first configuration and a second configuration, said tool having a different resting length in said first configuration than in said second configuration;
said tool comprising a handle;
and wherein, in either said first configuration or said second configuration, when said head is placed against a desired first object, and said base is placed against a desired second object, the user can move said handle to increase said resting length of said tool to exert force against the first object and the second object.

17. An apparatus as claimed in claim 16, wherein said resting length can be increased by the user to increase the distance between said first object and said second object.

18. An apparatus as claimed in claim 16, wherein, when the first object is an automobile, and the second object is the ground, said resting length can be increased by the user to provide sufficient force to lift the automobile using said tool.

19. An apparatus as claimed in claim 16, wherein, when the first object and the second object are the right and left doorposts of a door frame, said resting length can be increased by the user to provide sufficient force to expand the distance between those right and left doorposts.

20. An apparatus, comprising:
a tool comprising an upper component and a lower component;
said upper component comprising a head, and said lower component comprising a base, said tool further comprising a first tube of said upper component, and a second tube of said lower component, said first tube comprising a first pair of holes and a second pair of holes, said second tube comprising a first pair of holes and a second pair of holes;
wherein said first tube of said upper component and said second tube of said lower component can be connected together by a user in at least two configurations, a first configuration and a second configuration;
said first configuration being a configuration wherein said first pair of holes of said first tube is aligned with said first pair of holes of said second tube;
said second configuration being a configuration wherein said second pair of holes of said first tube is aligned with said second pair of holes of said second tube;
said first configuration and said second configuration each having a different resting length;
said tool comprising a handle, said handle being attached to a threaded rod;
and wherein, in either said first configuration or said second configuration, when said head is placed against a desired first object, and said base is placed against a desired second object, rotation of said handle rotates said threaded rod, increasing the resting length of said tool to exert force against the first object and the second object.

21. An apparatus as claimed in claim 20, wherein said tool comprises increased thickness in the region of said holes.
